(19) United States
(12) Patent Application Publication
(10) Pub. No.: US 2026/0259125 A1
(43) Pub. Date: Sep. 3, 2026

(54) INTERIOR CHARACTERIZATION OF OPAQUE INTERFACE-BOUND DOMAINS USING SURFACE-WAVE SPECTROSCOPY

(71) Applicant: Texas Tech University System, Lubbock, TX (US)

(72) Inventor: Sukalyan BHATTACHARYA, Lubbock, TX (US)

(73) Assignee: TEXAS TECH UNIVERSITY SYSTEM, Lubbock, TX (US)

(21) Appl. No.: 18/867,781

(22) PCT Filed: May 19, 2023
(86) PCT No.: PCT/US2023/067227

§ 371 Date: Nov. 20, 2024

Related U.S. Application Data
(60) Provisional application No. 63/344,320, filed on May 20, 2022.

(51) Int. Cl. G01N 15/02; G01N 15/00; G01N 15/10

(52) U.S. Cl. CPC G01N 15/0255; G01N 15/10; G01N 2015/0053; G01N 2015/1029

(57) ABSTRACT

Disclosed is a framework that performs interfacial spectroscopy for an interfacial wave characterization of a bubble-laden drop or similar interface-bound complex domains. The framework focuses on particle-laden droplets to be the representation of the plausible interface-bound systems. Accordingly, the impact of number, size and position of suspended solids on the frequency and decay spectra creating a coherently structured database can be determined, detected or otherwise identified and analyzed. Then, an inversion algorithm can be built so that the same particulate details can be extracted by comparing the experimentally recorded spectral data with the stored simulation results. Thirdly, the framework can perform experiments and/or analyses to check the effectiveness and accuracy of the entire detection process. Finally, the framework can provide a proof of uniqueness based on effective medium assumption that can be generalized for domains with discrete bodies to justify possible extension to more complex systems like living cells.

### CROSS-REFERENCE TO RELATED APPLICATION

The present application claims priority of U.S. Provisional Application No. 63/344,320 filed on May 20, 2022, entitled “Interior Characterization of Opaque Interface-Bound Domains Using Surface-Wave Spectroscopy,” the content of which is hereby incorporated by reference in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to interfacial spectroscopy, which exploits interfacial pulsation of a complex opaque domain, such as multiphase drops and/or cellular entities to determine what is inside them.

### SUMMARY

More particularly, according to some embodiments, the disclosed procedure includes two possible means to achieve the aforementioned objectives. With regard to the first of these uses, the experimentally obtained natural frequency spectra can be utilized to visualize the opaque interior of bodies, such as multiphase droplets where surface perturbations are immediately visible. In contrast, the second technique is applicable to more rigid systems, such as living cells where the recorded response spectra to sonic instigations characterizes the internal components. Both methods require basis function expansion to compute unsteady flow inside benchmark many-body domains that have known internal components. The resulting flow solutions and the interfacial conditions yield mass, damping and spring matrices for the system so that a benchmark database can be created. Then, the identification of the signature features in the frequency-decay spectra, as well as response spectra, provides the key tools for the detection process. Finally, interior of an unknown interface-bound body is described by matching the signature features of the experimentally observed vibration with the known simulated findings from the database.

Natural pulsations of interface-bound multiphase systems show waves with sinusoidal oscillation and exponential decay due to interplay between surface forces and viscous effects. It can be mathematically proven that the spectra of the frequencies and decay constants of such damped vibrations are uniquely related to the internal structure of the domain. This means that if these spectral quantities are recorded and post-processed properly, they can reveal what are inside an opaque fluid domain.

For example, bubble-laden drops have shown slightly deviating frequencies for a few modes forming bands akin to finer splits in atomic energy levels. There, the number of bands within certain range seems to indicate the number of cavities, while band-width and signature frequencies are related to positions and sizes of a specific void. Thus, the disclosed diagnostic method referred to as interfacial spectroscopy can detect the interior constituents of complex entities like multiphase drops or living cells. The disclosed framework evidences the viability and accuracy of this interfacial spectroscopy.

More specifically, according to some embodiments, the disclosed framework can operate (e.g., accomplish four tasks, for example) by focusing on particle-laden droplets to be the representation of the plausible systems. Accordingly, the impact of number, size and position of suspended solids on the frequency and decay spectra creating a coherently structured database can be determined, detected or otherwise identified and analyzed. Then, an inversion algorithm can be built so that the same particulate details can be extracted by comparing the experimentally recorded spectral data with the stored simulation results. Thirdly, the disclosed framework can perform experiments and/or analyses to check the effectiveness and accuracy of the entire detection process. Finally, the disclosed framework can provide a proof of uniqueness based on effective medium assumption that can be generalized for domains with discrete bodies to justify possible extension to more complex systems like living cells.

In some embodiments, a traditionally difficult step in the analysis requires computation of time-dependent hydrodynamic fields in presence of dissimilar disconnected bodies in particle-laden drop. As disclosed herein, the disclosed framework provides a solution method for unsteady flows where pressure and velocity are expanded in different sets of basis functions. In some embodiments, the disclosed framework can derive the mutual transformations between two of these sets to form systems of coupled ordinary differential equations. This allows for the identification of relevant mass, damping and spring matrices from which frequencies and decay constants can be obtained as the imaginary and real part of the Eigen values.

According to some embodiments, the approach can be viewed as a generalization of Stokesian analysis under steady condition, where only a mobility matrix is the matter of interest. Thus, as discussed herein, the disclosed framework, via its implementation and functionality, can lead to an entirely new technology similar to magnetic resonance imaging (MRI) or mass spectroscopy, for example.

According to some embodiments, successful identification of bubbles in an opaque droplet from the anomalous frequency has instigated the idea of interfacial spectroscopy. Multiphase drops appear in fuel combustion and liquid spraying where it is impossible to see the embedded species. If the frequency or decay constant of such systems are known, the known information can be used to estimate the size and number of cavities or particles trapped in the liquid. In the past, similar approaches have provided the capillary constant from the pulsation of a pure droplet. However, the disclosed framework provides a vast expansion of the detection method by exploiting all relevant spectral features of the system.

For example, interfacial spectroscopy can measure properties in different parts of a multispecies drop or a living cell, if their effects on the frequency and forcing response are known. Similarly, random fluctuations at the outer surface due to Brownian motion inside the domain can reveal many useful characteristics. Firstly, this can be used to characterize the size and concentration of Brownian particles. In addition, it can provide a means to estimate local temperatures inside an inaccessible interior. Such abilities can bring transformative changes in exploration of cellular dynamics.

According to some embodiments, a method is disclosed for performing interfacial spectroscopy for an interfacial wave characterization of a bubble-laden drop.

In accordance with one or more embodiments, the present disclosure provides a non-transitory computer-readable storage medium for carrying out the above mentioned technical steps. The non-transitory computer-readable storage medium has tangibly stored thereon, or tangibly encoded thereon, computer readable instructions that when executed by a device, cause at least one processor to perform a method for performing interfacial spectroscopy for an interfacial wave characterization of a bubble-laden drop.

In accordance with one or more embodiments, a system is provided that comprises one or more computing devices and/or apparatus configured to provide functionality in accordance with such embodiments. In accordance with one or more embodiments, functionality is embodied in steps of a method performed by at least one computing device and/or apparatus. In accordance with one or more embodiments, program code (or program logic) executed by a processor(s) of a computing device to implement functionality in accordance with one or more such embodiments is embodied in, by and/or on a non-transitory computer-readable medium.

According to some embodiments, additional disclosure related to the disclosed framework's capabilities and functionality can be found in APPENDIX A and APPENDIX B, which are appended to this paper.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example embodiment according to some embodiments of the present disclosure;

FIG. 4 illustrates an example embodiment according to some embodiments of the present disclosure;

FIG. 5 illustrates an example embodiment according to some embodiments of the present disclosure;

FIG. 6 illustrates an example embodiment according to some embodiments of the present disclosure; and

FIG. 7 is a block diagram illustrating a computing device showing an example of a device used in various embodiments of the present disclosure.

### DETAILED DESCRIPTION OF EXAMPLE EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as “up,” “down,” “bottom,” “top,” “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately,” are understood by those skilled in the art to refer to reasonable ranges around and including the given value and ranges outside the given value, for example, general tolerances associated with manufacturing, assembly, and use of the embodiments. The term “substantially,” when referring to a structure or characteristic, includes the characteristic that is mostly or entirely present in the characteristic or structure.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device, referred to as user equipment (UE)), may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

In some embodiments, as discussed below, the client device can also be, or can communicatively be coupled to, any type of known or to be known scientific instrument (e.g., or any type of known or to be known device used to separate and measure spectral components of a physical phenomenon), such as, but not limited to, a spectrometer, a MRI machine, computerized tomography (CT) scanner, neuromodulation or neurostimulation device, and the like, or some combination thereof.

A client device (UE) may vary in terms of capabilities or features. Indeed, as discussed herein, the client device can be connected to a scientific instrument, or operate as the scientific instrument.

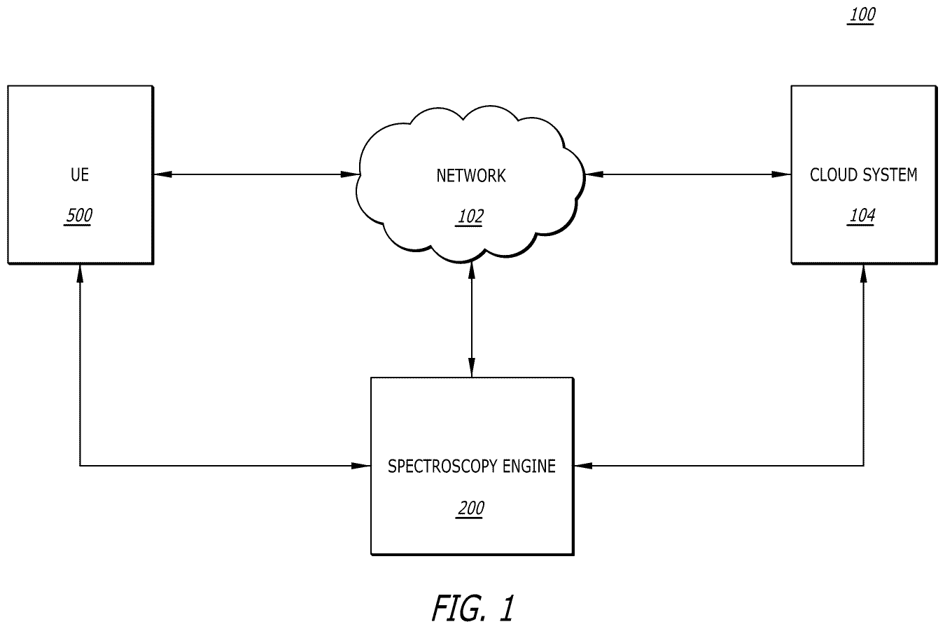

With reference to FIG. 1, system (or framework) 100 is depicted which includes UE 700 (e.g., a client device), network 102, cloud system 104 and spectroscopy engine 200. UE 700 can be any type of device, such as, but not limited to, a mobile phone, tablet, laptop, personal computer, sensor, Internet of Things (IoT) device, autonomous machine, and any other device equipped with a cellular or wireless or wired transceiver.

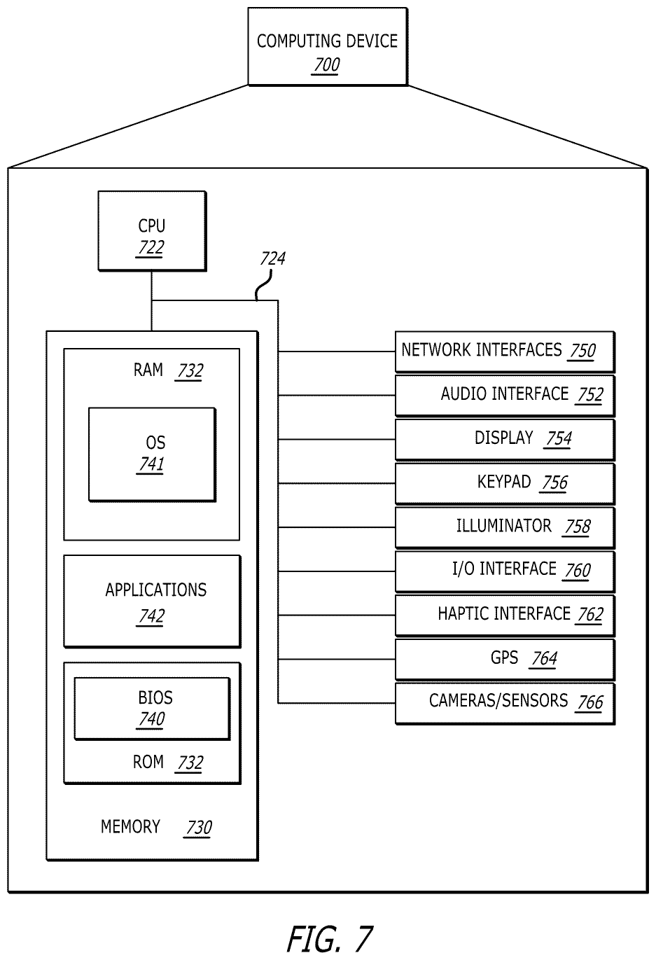

In some embodiments, as discussed above, UE 700 can also be a scientific instrument, or another device that is communicatively coupled to a scientific instrument that enables reception of information gathered via the scientific instrument. For example, in some embodiments, UE 700 can be a spectrometer. In another example, in some embodiments, UE 700 can be a user's smartphone that is connected via Wifi, Bluetooth Low Energy (BLE) or NFC, for example, to a peripheral spectrometer. Thus, in some embodiments, UE 700 can be configured to receive data from sensors associated with a scientific instrument, as discussed in more detail below. Further discussion of UE 700 is provided below at least in reference to FIG. 7.

Network 102 can be any type of network, such as, but not limited to, a wireless network, cellular network, the Internet, and the like (as discussed above). As discussed herein, network 102 can facilitate connectivity of the components of system 100, as illustrated in FIG. 1.

Cloud system 104 can be any type of cloud operating platform and/or network based system upon which applications, operations, and/or other forms of network resources can be located. For example, system 104 can correspond to a service provider, network provider and/or medical provider from where services and/or applications can be accessed, sourced or executed from. In some embodiments, cloud system 104 can include a server(s) and/or a database of information which is accessible over network 102. In some embodiments, a database (not shown) of system 104 can store a dataset of data and metadata associated with local and/or network information related to a user(s) of UE 700, patients and the UE 700, and the services and applications provided by cloud system 104 and/or spectroscopy engine 200.

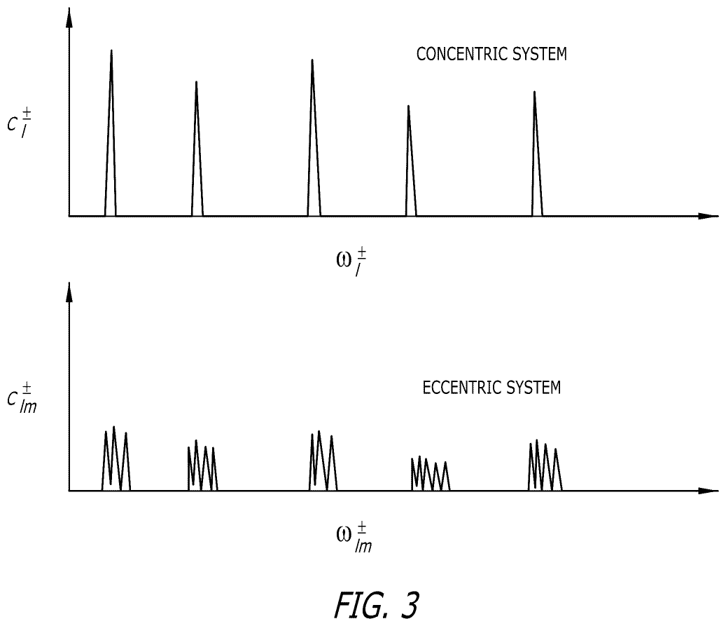

Spectroscopy engine 200, as discussed below in more detail, includes components for performing interfacial spectroscopy for an interfacial wave characterization of a bubble-laden drop. Embodiments of how this is performed via engine 200, among others, are discussed in more detail below in relation to FIGS. 3-6.

According to some embodiments, spectroscopy engine 200 can be a special purpose machine or processor and could be hosted by a device on network 102, within cloud system 104 and/or on UE 700. In some embodiments, engine 200 can be hosted by a peripheral device connected to UE 700 (e.g., a spectrometer, as discussed above).

According to some embodiments, spectroscopy engine 200 can function as an application provided by cloud system 104. In some embodiments, engine 200 can function as an application installed on UE 700. In some embodiments, such application can be a web-based application accessed by UE 700 over network 102 from cloud system 104 (e.g., as indicated by the connection between network 102 and engine 200, and/or the dashed line between UE 700 and engine 200 in FIG. 1). In some embodiments, engine 200 can be configured and/or installed as an augmenting script, program or application (e.g., a plug-in or extension) to another application or program provided by cloud system 104 and/or executing on UE 700.

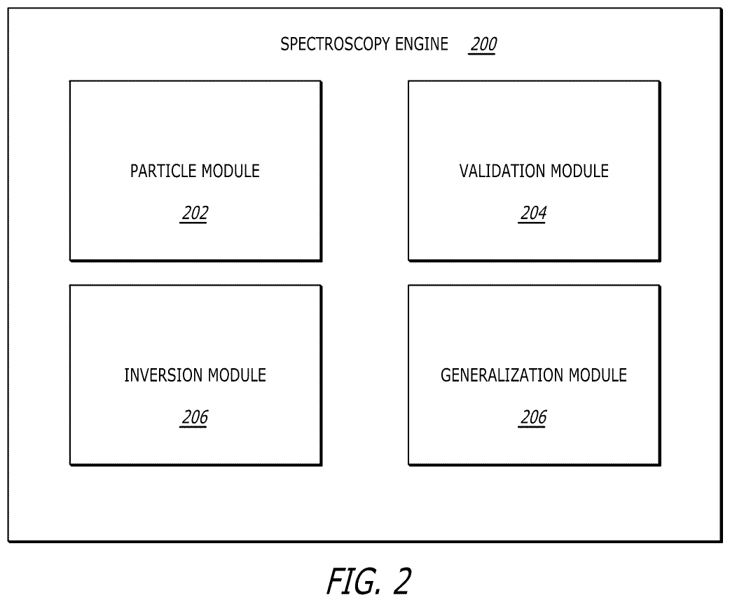

As illustrated in FIG. 2, according to some embodiments, spectroscopy engine 200 includes particle module 202, inversion module 204, validation module 206 and generalization module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning now to FIGS. 3-6, disclosed are embodiments for the disclosed framework that performs interfacial spectroscopy for an interfacial wave characterization of a bubble-laden drop. The framework operates by focusing on particle-laden droplets to be the representation of the plausible systems. Accordingly, the impact of number, size and position of suspended solids on the frequency and decay spectra creating a coherently structured database can be determined, detected or otherwise identified and analyzed. Then, an inversion algorithm can be built so that the same particulate details can be extracted by comparing the experimentally recorded spectral data with the stored simulation results. Thirdly, the framework can perform experiments and/or analyses to check the effectiveness and accuracy of the entire detection process. Finally, the framework can provide a proof of uniqueness based on effective medium assumption that can be generalized for domains with discrete bodies to justify possible extension to more complex systems like living cells.

According to some embodiments, the disclosed framework (e.g., engine 200) can execute a process of steps via the modules 202-208 (e.g., broad steps that have detailed sub-steps, as outlined below) for testing and determining viability of the detection procedure by focusing on a particulate drop.

According to some embodiments, engine 200 can operate by studying interfacial waves in freely pulsating particle-laden drop. In some embodiments, as discussed below, different spectral features reveal different aspects of the suspended particles. In some embodiments, the number of frequency bands in specified spectral spans is directly related to number of suspended bodies. Similarly, a few signature frequencies are indicative to the size of the solids whereas widths of the bands are manifestation of the particulate position. Simulations of the disclosed framework's operation have verified such hypothesis thereby creating a systematically built coherent database.

According to some embodiments, engine 200 can then generate and execute an inversion algorithm for detection from spectral measurements. In some embodiments, the disclosed framework indicates that experimentally measured frequencies and decays are uniquely related to the internal structure. As discussed herein, the disclosed framework can formulate and evidence a post-processing algorithm that extracts the number, size and position of the particles from the observed details of the spectra.

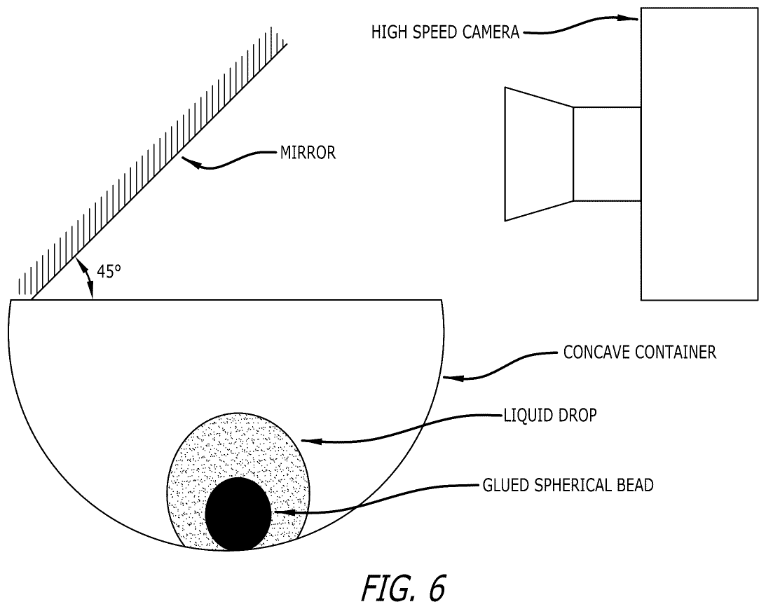

According to some embodiments, engine 200 can validate experimental investigations, as discussed below, in order to determine and confirm the effectiveness and accuracy of the entire detection process. For example, a set-up involving a transparent concave container, liquid drop over glued beads, a mirror and a high speed camera validated results for domains with peripherally located single sphere (as illustrated in FIG. 6). As discussed herein, the framework can improve the arrangement for more general systems to check the predictive capability of the inversion algorithm.

According to some embodiments, engine 200 can perform a generalization of the uniqueness theorem thereby proving the uniqueness of the spectra for different internal structures by extending the classical proof of Bourget's hypothesis. According to some embodiments, execution of engine 200 and the generalization therefrom can be based on an effective medium, where the suspended species are small and numerous enough (to a threshold amount).

According to some embodiments, the disclosed framework provides novel mechanisms which can create an entirely new technology with wide range of possible applications. For example, it can provide a detection tool akin to MRI or mass spectroscopy that can be used in various field from cellular exploration to characterization of multiphase systems, thereby revolutionizing diagnostic capabilities.

Accordingly, this can lead to related studies to determine an effectiveness of acoustically induced droplet break-up for better combustion efficiency or cellular destruction for oncological treatments. Thus, the disclosed framework provides novel potential of such multi-facetted high-impact relevance in contemporary research fields.

According to some embodiments, the disclosed framework's operability can leverage developed methodologies for solving unsteady flow near closely situated many disconnected dissimilar interfaces. Similarly, the disclosed framework can set-up with a drop(s) embedded with a single bead, which is innovative for systems with many particles. Finally, importing and extending the proof for Bourget's hypothesis to establish unique relation between spectra and internal structure is novel in the analysis of fluid-structure interactions. Thus, such novelties and the complexities evidence a novel framework, as discussed herein.

According to some embodiments, interfacial spectroscopy has two components. The first is the computation of unsteady flow inside a many-body domain using basis function expansion leading to mass, damping and spring matrices evaluated from the interfacial conditions. The second part involves identification and exploitation of signature features in the frequency and decay spectra obtained from the computed matrices.

In some embodiments, the analysis can and has been used to find natural frequencies of a drop of radius a₀ with an embedded bubble of size-ratio a\tilde{ } at an eccentric position R. The results show dramatic contrast between bands of clustering frequencies for eccentric systems and isolated peaks in concentric cases.

Accordingly, the frequency-amplitude plot in FIG. 3 illustrates this behavior, where the finer splits like atomic energy levels appear if the bubble is in an eccentric position. Eccentric systems have more intriguing spectra due to the azimuthal modes with an additional quantum number m beside the nominal one denoted as l and configurational index ±. Then, different m values can create small deviations in frequencies around the value dictated by l and configuration + or − under a concentric condition. Thus, the spectral quantities forms distinct bands with closely grouped peaks denoted by ω\tilde{ }^{±}ₗₘ. This is akin to finer structure in atomic spectra, where different quantum numbers ensure small deviation in energy levels. The phenomenon is presented in FIG. 3.

FIG. 3 depicts an appearance of finer splits in spectral response for eccentric position of a bubble inside a drop, which is demonstrated by an amplitude vs. frequency plot revealing natural modes of pulsation for the system. The amplitude C is non-zero when natural frequency ω is matched in the spectral space. There are two quantum numbers l and m corresponding to spherical harmonics dictate the shape of the surface waves. Additionally, two configurational modes + and − represent two possible mutual orientations of the internal and external interfaces. For centrally placed bubble, natural frequencies for different m coincide to a unique value ω^{±}₁ₘ, whereas small deviations can be defined by ω^{±}ₗₘ, and appear as the system becomes eccentric.

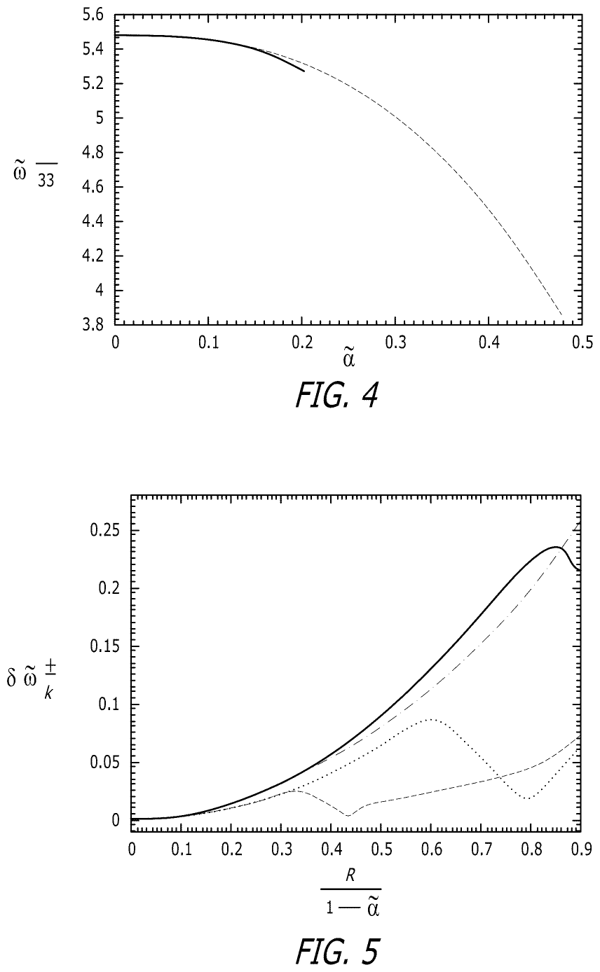

Accordingly, the parametric variations of frequencies for different modes reveal the signature features for the detection process. In some embodiments, the frequency for the minus mode with l=m varies very slowly with position R, but exhibits perceptible change with a\tilde{ }. This is illustrated in FIG. 4 where ω\tilde{ }⁻₃₃ is plotted as function of a\tilde{ } for four different R, though all four curves collapse on each other making them indistinguishable. Hence, the disclosed diagnostic scheme recognizes this as a signature parameter which directly reveals a\tilde{ }. Then, R can be determined from a second group of signature features in the form of widths of the fine-structure band described in FIG. 5. Thus, it becomes possible to find both a\tilde{ } and R from the wave spectra as disclosed herein for interfacial spectroscopy.

In FIG. 4, signature feature ω\tilde{ }3−3 is plotted as function of void-fraction for two positions of the void at R=0.2 (thick line) and R=0.5 (thin line). The two curves are separated by only 0.1% mean deviation. Therefore, it can be concluded that the modal frequency ω\tilde{ }⁻₃₃ to be a signature feature for the parametric space directly providing a\tilde{ } irrespective of the value of R. Accordingly, as discussed herein, this can be leveraged for the disclosed data inversion scheme for effective characterization of multiphase drops.

In FIG. 5, the band-widths are considered as the second signature feature which can reveal the position of the gas bubble after size-ratio is determined from ω\tilde{ }⁻₃₃. Here, band-widths of non-dimensional frequencies are plotted as functions of normalized position for (−) configurational mode with l=2 (solid line) and l=3 (dash-dot line) as well as (+) configurational mode with l=2 (dashed line) and l=3 (dotted line), when a size-ratio is 0.5.

Moreover, as discussed herein, to provide a mathematical foundation for the inversion operations, an one-to-one correspondence between the entire wave spectra and the internal structure of the system can be utilized. For this purpose, the embedded species is assumed to be both small and numerous so that their existence can be modeled by a spatially varying viscosity of an effective medium. In some embodiments, a specific spectra at its entirety with all frequencies and decay constants for all possible modes can be generated by a unique variation in the effective viscosity.

According to some embodiments, engine 200 can first convert the flow equation with variable viscosity in a temporally invariant Sturm-Liouville form exploiting separable solutions in space and time. Then, the required uniqueness can be proven in two different ways—using either a matrix representation or the properties of definite integrals as inner product. Such theory can be viewed as essentially an extension of the proof for Bourget's hypothesis in connection to the uniqueness of the roots of Bessel functions. Accordingly, embodiments exist where this can be generalized for arbitrary systems with larger and fewer embedded species without departing from the scope of the instant disclosure.

Accordingly, the disclosed framework operates the disclosed processing via execution by engine 200 by first building a hierarchical library uniquely relating the features of wave spectra to the size, number and position of solid bodies in a viscous drop (e.g., execution of module 202 of engine 200). Then, an inversion scheme can be formulated by exploiting the aforementioned database to extract the same particulate details when spectral information is provided (e.g., execution of module 204 of engine 200). Thirdly, correctness of the stored simulation data and effectiveness of the inversion will be verified by experiments using recently designed set-up (e.g., execution of module 206 of engine 200). Finally, the uniqueness theorem assuming effective medium will be generalized for large embedded objects establishing mathematical foundation of interfacial spectroscopy for complex systems (e.g., execution of module 208 of engine 200).

According to some embodiments, engine 200 can perform a simulation of the wave spectra for a multiphase drop. In some embodiments, this can involve finding the frequency and decay spectra of drops with a few bubbles or particles or their mixtures. In some embodiments, as discussed above, a number of frequency bands within given spectral spans indicates the number of internal species as well as their types. More specifically, the number of bands in the low frequency regime should be equal to the number of subdomains defined by either gas cavities or solid bodies. Furthermore, number of such groups will be twice more for bubbles compared to the particles in high spectral regimes. Also, as in systems with single-object interior, specific frequencies and corresponding band-widths should reveal the size and the position of different interfaces inside a many-body domain. Thus, in some embodiments, engine 200 can operate to check these postulates

Subsequently, engine 200 (via module 202) can identify key spectral features like specific frequencies or band-widths or band-spacings as signatures for corresponding structural parameters. The relation between the spectral and structural quantities can be stored in an ordered database to facilitate the detection.

In some embodiments, an improved Bond number expansion can be utilized so that distortions by gravity can be properly represented in the data. Also, a correction may be needed to account for particles with restricted motion to be determined. The last two adjustments may be important for matching a spectroscopic estimation with experimental systems used in the disclosed framework's set-up.

In some embodiments, engine 200 (via module 204) can then perform a formulation of the inversion algorithm. In some embodiments, the database and the signature parameters from the earlier simulations can be used to build an inversion algorithm which can reveal the interior structure from a given spectra. As a pre-condition, the scheme may need the experimentally obtained positions of interfacial points as function of time t and angle θ in observation plane. This data can be first convoluted with Legendre polynomials of cos θ, and the resulting unsteady amplitudes can be converted in complex Fourier space. The final time-invariant complex Eigen values can give frequencies and decay constants in the spectral span defined by the temporal and spatial resolution in the recording.

In a next step, engine 200 can quantify the relevant signature features from the experimental spectra. Then, the stored database would be used to determine the structural parameters like number of particles, number of bubbles, their sizes and their positions. After this, corrections from bond-number perturbation and external-constraint analysis can modify the estimation in an iteration. The converged results can be presented as the prediction of interfacial spectroscopy. This processing is applicable to systems with single spheres, as well as complex drops with more solid objects and gas cavities in it.

In some embodiments, engine 200 (via module 206) can then perform experimental validation of interfacial spectroscopy. In some embodiments, the accuracy of the created database and constructed inversion scheme can be validated using the disclosed experimental set-up with liquid drop in a concave container (see, e.g., FIG. 6). The arrangement can be modified in two ways so that two different experiments can be done.

In some embodiments, a first set of experiments can be a natural extension of the ones discussed in preliminary studies. The only difference between the present and the proposed set-ups would be the usage of many thread-supported beads in the latter instead of a single glued sphere in the former. The thread-linked supports would allow the introduction of multiple spheres and to manipulate their positions. Thus, a representative parametric space can be explored, and the spectroscopy theory can be verified for a wide range of internal structures.

In some embodiments, a second experiment can consider systems with liquid-liquid interfaces. For this purpose, a compound droplet with a mass of oil inside a drop of water can be used. The goal of this study is to show that twice more bands appear in high-frequency regime when a bubble or a liquid is embedded instead of a solid. This requires better camera and lens though, as higher spectra can only be captured with more resolution.

In some embodiments, engine 200 (via module 208) can perform a generalization of the uniqueness theorem. In some embodiments, the uniqueness theorem from a currently considered effective medium with small and numerous interior subdomains can be extended to systems with fewer and larger drops or particles. It is to be noted that if the relation between spectra and structure is unique even for small and numerous species, one of skill in the art can expect this to be true for a domain with fewer and more prominent components.

According to some embodiments, the integral properties of products of Eigen functions for two systems can be analyzed and exploited to show the impossibility of having exact same spectra with two different structure. Secondly, the differential equations in matrix form can be cast, such that the proof by successive operations leading to a unique relation between two blocks representing spectra and structure can be realized, respectively.

According to some embodiments, the disclosed framework involve several non-trivial numerical and mathematical components. For example, the analysis performed uses a new solution technique for computing unsteady flow around closely situated disconnected dissimilar interfaces. Similarly, it imports and extends the proof for Bourget's hypothesis to show the unique correspondence between wave spectra and internal structures. These formulations will lead to an experimental capability for detection of particles and bubbles inside an opaque drop. Moreover, the technique can be extended to exploration of complex biological systems like living cells. Thus, according to some embodiments, one of skill in the art would readily understand that the framework can be applicable in a wide range of fields, including, but not limited to, fluid mechanics, combustion, material processing and cell biology, and the like.

Moreover, the disclosed framework can have an intrinsic potential for industrial and clinical applications. For example, the framework can further applicability to the performance and processing of paints, inks and armors, and the like. Firstly, the diagnostic tool based on the disclosed methodologies can ensure in-vivo quality control for consistency. Secondly, the sonically induced size-manipulation can enhance their effectiveness by creating finer drops needed in each of these products. The capability is also crucial in large-scale pharmaceutical production reducing cost of the resulting drugs.

Indeed, the disclosed framework can be used to obtain granular details of cellular properties useful in cancer research. Cancerous cells have thicker nuclear matter and larger nucleus whose detection can help to understand oncological diseases. Similarly, microfilaments and cell membranes lose their elasticity with age; as such, the disclosed framework's operability and estimation can be used to study geriatric ailments.

FIG. 7 is a block diagram illustrating a computing device 700 (e.g., UE 700, as discussed above) showing an example of a client device or server device used in the various embodiments of the disclosure.

The computing device 700 may include more or fewer components than those shown in FIG. 7, depending on the deployment or usage of the device 700. For example, a server computing device, such as a rack-mounted server, may not include audio interfaces 752, displays 754, keypads 756, illuminators 758, haptic interfaces 762, GPS receivers 764, or cameras/sensors 766. Some devices may include additional components not shown, such as graphics processing unit (GPU) devices, cryptographic co-processors, AI accelerators, or other peripheral devices.

As shown in FIG. 7, the device 700 includes a central processing unit (CPU) 722 in communication with a mass memory 730 via a bus 724. The computing device 700 also includes one or more network interfaces 750, an audio interface 752, a display 754, a keypad 756, an illuminator 758, an input/output interface 760, a haptic interface 762, an optional GPS receiver 764 (and/or an interchangeable or additional GNSS receiver) and a camera(s) or other optical, thermal, or electromagnetic sensors 766. Device 700 can include one camera/sensor 766 or a plurality of cameras/sensors 766. The positioning of the camera(s)/sensor(s) 766 on the device 700 can change per device 700 model, per device 700 capabilities, and the like, or some combination thereof.

In some embodiments, the CPU 722 may comprise a general-purpose CPU. The CPU 722 may comprise a single-core or multiple-core CPU. The CPU 722 may comprise a system-on-a-chip (SoC) or a similar embedded system. In some embodiments, a GPU may be used in place of, or in combination with, a CPU 722. Mass memory 730 may comprise a dynamic random-access memory (DRAM) device, a static random-access memory device (SRAM), or a Flash (e.g., NAND Flash) memory device. In some embodiments, mass memory 730 may comprise a combination of such memory types. In one embodiment, the bus 724 may comprise a Peripheral Component Interconnect Express (PCIe) bus. In some embodiments, the bus 724 may comprise multiple busses instead of a single bus.

Mass memory 730 illustrates another example of computer storage media for the storage of information such as computer-readable instructions, data structures, program modules, or other data. Mass memory 730 stores a basic input/output system (“BIOS”) 740 for controlling the low-level operation of the computing device 700. The mass memory also stores an operating system 741 for controlling the operation of the computing device 700.

Applications 742 may include computer-executable instructions which, when executed by the computing device 700, perform any of the methods (or portions of the methods) described previously in the description of the preceding Figures. In some embodiments, the software or programs implementing the method embodiments can be read from a hard disk drive (not illustrated) and temporarily stored in RAM 732 by CPU 722. CPU 722 may then read the software or data from RAM 732, process them, and store them to RAM 732 again.

The computing device 700 may optionally communicate with a base station (not shown) or directly with another computing device. Network interface 750 is sometimes known as a transceiver, transceiving device, or network interface card (NIC).

The audio interface 752 produces and receives audio signals such as the sound of a human voice. For example, the audio interface 752 may be coupled to a speaker and microphone (not shown) to enable telecommunication with others or generate an audio acknowledgment for some action. Display 754 may be a liquid crystal display (LCD), gas plasma, light-emitting diode (LED), or any other type of display used with a computing device. Display 754 may also include a touch-sensitive screen arranged to receive input from an object such as a stylus or a digit from a human hand.

Keypad 756 may comprise any input device arranged to receive input from a user. Illuminator 758 may provide a status indication or provide light.

The computing device 700 also comprises an input/output interface 760 for communicating with external devices, using communication technologies, such as USB, infrared, Bluetooth™, or the like. The haptic interface 762 provides tactile feedback to a user of the client device.

The optional GPS transceiver 764 can determine the physical coordinates of the computing device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS, or the like, to further determine the physical location of the computing device 700 on the surface of the Earth. In one embodiment, however, the computing device 700 may communicate through other components, provide other information that may be employed to determine a physical location of the device, including, for example, a MAC address, IP address, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising the steps of:
determining, by a device, information related to a frequency spectrum and a delay spectrum of a particular interface-bound system;
determining, by the device, a plurality of features in the information corresponding to ones of a plurality of structural parameters of the particular interface-bound system;
storing, by the device, in a database, the plurality of features and the plurality of structural parameters;
determining, by the device, an inversion algorithm using the database; and
validating, by the device, interfacial spectroscopy using the database, the inversion algorithm, and experimental frequency and delay spectra associated with an experimental setup.

2. The method of claim 1, further comprising:
determining, by the device, different frequency and delay spectra associated with a different interface-bound system; and
determining, by the device, structural information associated with the different interface-bound system using the database and the inversion algorithm.

3. The method of claim 2, wherein the structural information associated with the different interface-bound system includes at least a number of particles included in the different interface-bound system.

4. The method of claim 1, wherein determining the plurality of features includes correcting for distortions by gravity.

5. The method of claim 1, wherein determining the plurality of features includes correcting for particles with restricted motion.

6. The method of claim 1, further comprising generalizing, by the device, a uniqueness theorem for another interface-bound system using results generated during a validation operation.

7. A non-transitory computer-readable storage medium tangibly encoded with computer-executable instructions, that when executed by a device, cause the device to perform steps comprising:
determining, by a device, information related to a frequency spectrum and a delay spectrum of a particular interface-bound system;
determining, by the device, a plurality of features in the information corresponding to ones of a plurality of structural parameters of the particular interface-bound system;
storing, by the device, in a database, the plurality of features and the plurality of structural parameters;
determining, by the device, an inversion algorithm using the database; and
validating, by the device, interfacial spectroscopy using the database, the inversion algorithm, and experimental frequency and delay spectra associated with an experimental setup.

8. The non-transitory computer-readable storage medium of claim 7, wherein the step further include:
determining, by the device, different frequency and delay spectra associated with a different interface-bound system; and
determining, by the device, structural information associated with the different interface-bound system using the database and the inversion algorithm.

9. The non-transitory computer-readable storage medium of claim 8, wherein the structural information associated with the different interface-bound system includes at least a number of particles included in the different interface-bound system.

10. The non-transitory computer-readable storage medium of claim 7, wherein determining the plurality of features includes correcting for distortions by gravity.

11. The non-transitory computer-readable storage medium of claim 7, wherein determining the plurality of features includes correcting for particles with restricted motion.

12. The non-transitory computer-readable storage medium of claim 7, wherein the steps further include generalizing, by the device, a uniqueness theorem for another interface-bound system using results generated during a validation operation.

13. The non-transitory computer-readable storage medium of claim 7, wherein determining the inversion algorithm includes comparing experimentally recorded spectral data with data included in the database.

14. A device comprising:
a processor configured to:
determine information related to a frequency spectrum and a delay spectrum of a particular interface-bound system;
determine a plurality of features in the information corresponding to ones of a plurality of structural parameters of the particular interface-bound system;
store in a database, the plurality of features and the plurality of structural parameters;
determine an inversion algorithm using the database; and
validate interfacial spectroscopy using the database, the inversion algorithm, and experimental frequency and delay spectra associated with an experimental setup.

15. The device of claim 14, wherein the device is further configured to:
determine different frequency and delay spectra associated with a different interface-bound system; and
determine structural information associated with the different interface-bound system using the database and the inversion algorithm.

16. The device of claim 15, wherein the structural information associated with the different interface-bound system includes at least a number of particles included in the different interface-bound system.

17. The device of claim 14, wherein to determine the plurality of features, the device is further configured to correct for distortions by gravity.

18. The device of claim 14, wherein to determine the plurality of features, the device is further configured to correct for particles with restricted motion.

19. The device of claim 14, wherein the device is further configured to generalize a uniqueness theorem for another interface-bound system using results generated during a validation operation.

20. The device of claim 14, wherein to determine the inversion algorithm, the device is further configured to compare experimentally recorded spectral data with data included in the database.
